(19) United States
(12) Patent Application Publication
(10) Pub. No.: US 2005/0186310 A1
(43) Pub. Date: Aug. 25, 2005

(54) Novel process for treating foods under alternating atmospheres

(76) Inventors: Joseph E. Paganessi, Burr Ridge, IL (US); James T.C. Yuan, Naperville, IL (US); Omar Germouni, Chicago, IL (US)

Correspondence Address: AIR LIQUIDE, 2700 POST OAK BOULEVARD, SUITE 1800, HOUSTON, TX, 77056, US

(21) Appl. No.: 11/059,044

(22) Filed: Feb. 15, 2005

Related U.S. Application Data
(60) Provisional application No. 60/546,288, filed on Feb. 20, 2004.

(51) Int. Cl. A23B 4/00

(52) U.S. Cl. 426/321

(57) ABSTRACT

This disclosure discusses the problems associated with preservation of food products while avoiding undesirable high pressures, additives, or other chemical treatments. The disclosed invention will reduce spoilage in food products, particularly liquid food products, by removing oxidants, enzymes, and killing bacteria without using heat or undesirable additives. The process of the invention uses a combination of moderate pressure and reactive gases, such as carbon dioxide or nitrous oxide to treat food products, and then removes the reactive gases by purging the food product with an inert gas. The final product is substantially free of unwanted microorganisms, enzymes, and oxidants that cause spoilage of the food product.

### CROSS REFERENCES

This application is related to and claims the benefit of U.S. Provisional Application No. 60/546,288, filed Feb. 20, 2004, entitled “Method and Process of Treating Liquid Foods Under Alternating Atmospheres.”

### BACKGROUND

The present invention relates to processes for preserving food or food products, and particularly to processes for preserving food or a food product against microbial contamination using alternating treatment environments.

Food and food products, including packaged foods, are generally subject to two main problems: microbial contamination and quality deterioration. The primary problem regarding food spoilage in public health is microbial growth. If pathogenic microorganisms are present, then growth of such microorganisms can potentially lead to food-borne outbreaks and significant economic losses. Since 1997, food safety concerns have increasingly been brought to the consumer's attention, and those concerns have become even stronger today. Recent outbreaks from Salmonella and E. coli 0157:H7 have increased the focus on food safety from a regulatory perspective, as well. A recent study completed by the Centers for Disease Control and Prevention (CDC) estimated that food-borne diseases cause approximately 76 million illnesses, 325,000 hospitalizations and 5,000 deaths annually in the U.S. Those numbers reveal the dramatic need for effective means for preserving food and food products in order to ensure food safety.

Currently, food manufacturers use different technologies to eliminate, retard, or prevent microbial growth. However, effective sanitation depends on the product/process type, and not all currently available technology can deliver an effective reduction of microorganisms. Instead, another level of health problems may be created, or the quality of the treated food may deteriorate. For example, chlorine has been widely used as a sanitizer of choice since World War I. However, concerns regarding the safety of carcinogenic and toxic byproducts of chlorine, such as chloramines and trihalomethanes, have been raised in recent years. Another example is heat treatment. Even though heat is very efficient in killing bacteria, it also destroys some nutrients, flavors, or textural attributes of food and food products.

Physical manipulations of food products that have a sanitizing or preservative effect include, for example, freezing, refrigerating, cooking, retorting, pasteurizing, drying, pressurizing, vacuum packing, and sealing in an oxygen-free package. Some of these approaches can be one part of a more complex food processing operation. Food processing steps are selected to strike a balance between obtaining a microbially safe food product, while producing a food product with desirable qualities.

Freezing is a very common method known to stop microbial growth and preserve food products. However, freezing can adversely affect the taste and texture of many food products. Consumer demand for fresh, non-frozen food products has increased significantly in recent years.

Food deterioration is also caused by oxidation, or by enzyme reactions. Preservatives with antioxidant activity can be added to lock up the oxygen and prevent enzyme reactions. Although some food additives effectively stop enzyme reactions, some consumers disfavor added non-natural chemical preservatives. Some chemical preservatives such as citric acid and lactic acid are perceived to be natural and correspondingly more desirable. Some natural preservatives may be effective at providing an enzyme inhibited and microbially safe food product. However, to be effective, concentrations are required that can adversely affect the taste and texture of many food products, such as dough products and alimentary pastes. Furthermore, even though food preservatives with antioxidant activity have been successfully used in some food products, the consumer demand for natural food products brings new concerns for using chemical additives.

The effects of very high pressure (up to 120,000 PSI) on food microorganisms were first studied as early as 1899 on milk, meats, fruits and vegetables. Many foods appear to be particularly favorable to ultra high pressure food preservation, such as acidic foods that naturally inhibit surviving spore nucleation. U.S. Pat. No. 1,355,476 (Hering), U.S. Pat. No. 1,711,097 (Kratzer), and U.S. Pat. No. 1,728,334 (Crowther) discuss various processes for subjecting food products to high pressures to destroy micro organisms in the food. However, high pressure processing involves expensive equipment, high energy costs, and can affect the texture of the food products.

Therefore, there is a need in the food industry, and more specifically to the liquid food products industry, to develop economical food preservation processes that will eliminate the potential dangers of spoiling by microbial growth, oxidation, and enzymatic reactions in the food products without adversely effecting the inherent flavors of the foods, and without using undesirable additives, or very high pressures.

### SUMMARY

The current invention satisfies the need to provide safe food products while maintaining the inherent flavors of the foods, avoiding the use of artificial additives, and avoiding the use of very high pressures in the processing of the food. The current invention improves the quality and enhances the safety of food products by using a gas treatment of a reacting gas (such as CO₂ or N₂O) under a moderate pressure followed by removal of the reacting gas using an inert gas exchange process. The combination of the reacting gas pretreatment and inert gas treatment kills bacteria, prevents treated food from oxidizing, and stops enzyme reactions while concurrently minimizing the effect on food taste or appearance.

The treatment process of the current invention treats food products, particularly liquid food products, in a processing system by feeding a reactive gas to a food processing system to establish a first pressure in the food processing system and holding the first pressure for a period of time sufficient to treat the food product. An inert gas is then fed into the food processing system to remove residual reactive gases from the product. The combination of the residual reactive gas and the inert gas are removed from the food processing system, leaving the food substantially free of any treatment gases that could affect the taste of the food product.

In alternate embodiments of the current invention:
the reactive gas is released from the food processing system;
the reactive gas is ozone, CO₂, N₂O, or mixtures thereof;
the food product is a liquid food product;
the first pressure is about 50-2500 psig;
the first pressure is about 500-2500 psig;
the feeding inert gas step follows the releasing the reactive gas step;
the removing step follows the feeding inert gas step;
the releasing step establishes a second pressure in the food processing system, wherein the second pressure is about 0 to about 50 psig;
the releasing step establishes a second pressure in the food processing system, wherein the second pressure is a vacuum of about 1 to about 29.95 inches of mercury;
the inert gas is N₂, He, Ar, Kr, Xe, Ne, or mixtures thereof;
the inert gas is filtered to prevent contamination of the food product by microbes, bacteria, viruses, or spores;
the first temperature in the food processing system of about 0-70° C.;
the first temperature is established before the releasing step, and a second temperature is established in the food processing system after the holding step;
the second temperature is about 0-40° C.;
the reactive gas is fed through a membrane, sparger, or combinations thereof;
the inert gas is fed through a membrane, sparger, or combinations thereof;

### BRIEF DESCRIPTION OF DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a flowchart of the current method.

FIG. 2 is a schematic of one embodiment of a system for implementing the inventive method.

FIG. 3 is a schematic of another embodiment of a system for implementing the inventive method.

### DESCRIPTION OF PREFERRED EMBODIMENTS

The current invention improves the quality and enhances the safety of beverage products by treating food products with a reactive gas for a period of time followed by removal of the reactive gas and purging with inert gas. The resulting food product is substantially free of live bacteria, oxygen, and of enzyme reactions in the food product. Furthermore, the level of the reactive gas is reduced to levels that do not adversely affect the taste, texture, or color of the food product.

As used herein, the phrase “food” or “food product” generally refers to all types of foods, including, but not limited to, meats, including ground meats, poultry, seafood, produce including vegetables and fruit, dry pasta, breads, cereals, and fried, baked, or other snack foods. In a preferred embodiment, the food is in liquid form, such as beverages or juices. The current inventive method may be used in conjunction with any food that is able to support microbial, i.e. fungal, bacterial or viral growth, including unprocessed or processed foods. The food or food product must generally be compatible with the method of the current invention, particularly with the pressure treatment.

As used herein, “reactive gas” or “anti-microbial gas” refers to gases injected into the food processing system to kill or weaken pathogenic microorganisms on or in the food product. The reactive gas is any gas known to one of ordinary skill in the art to kill bacteria and/or stop enzyme reactions in food products. Preferred reactive gases include, but are not limited to, carbon dioxide (CO₂), nitrous oxide (N₂O), ozone, or mixtures of these gases.

As used herein, the terms “sanitize” and “disinfect”, as well as variations thereof, generally mean the reduction of the microbial and/or spore content of food. The terms “substantially sanitize” and “substantially disinfect” refer to the attainment of a level of microorganisms and/or spores in the food such that the food or food product is safe for consumption by a mammal, particularly by humans. Generally, as used herein, these terms refer to the elimination of at least about 90.0 to 99.9% of all microorganisms and/or spores, including pathogenic microorganisms, in the treated food or food product. Preferably, at least about 90.0 to 99.99%, and more preferably at least about 90.0 to 99.999% of such microorganisms and/or spores, are eliminated.

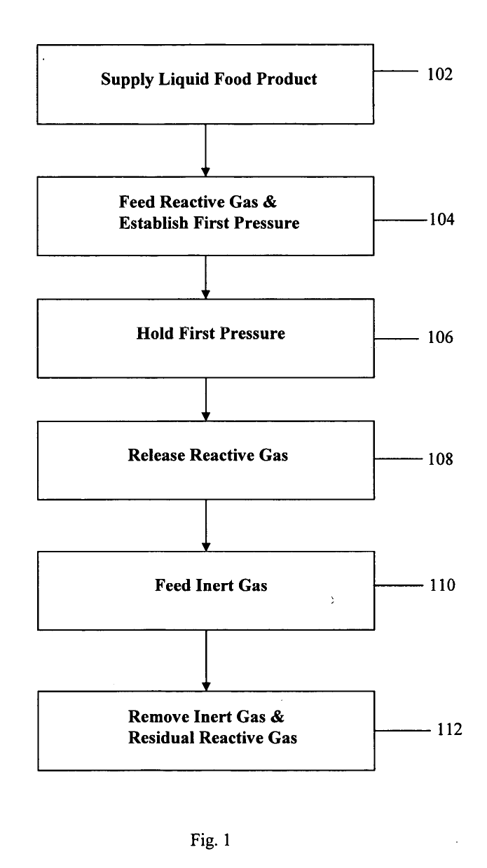

Referring to FIG. 1, the process comprises the steps of supplying a food product to a food processing system 102, and feeding a reactive gas to establish a first pressure in the food processing system 104. The process holds the first pressure a period of time effective to kill or significantly weaken microorganisms in the food product 106. The reactive gas and any products of reaction are then purged from the food product by feeding an inert gas to the food processing system 110 and removing the inert gas and residual reactive gas from the food processing system 112.

The inert gas may be filtered by a sub-micron filter to prevent contamination of the food product by microbes, bacteria, viruses, or spores. In one preferred embodiment, the process includes a step of releasing the reactive gas pressure from the system 108, before feeding the inert gas to the food product 110. The food product exits the processing system substantially free of live bacteria, oxygen, and of enzyme reactions in the food product.

The food processing system can be any system known to one of ordinary skill in the art for processing foods wherein the food product may be pressurized. The food processing system may be, but is not limited to, a pressure tank, a series of pressure tanks, a pump and piping system, or a progressive cavity pumping system.

The food product comprises any food product that has a state in which gases may bubble and/or permeate through or into the food. In one preferred embodiment, the food products are liquid food products such as juices, water, soups, beverages, syrups, oils, dressings, and sauces (ketchup, BBQ sauce, etc.). The liquids may contain some amounts of solids, such as the pulp in orange juice.

Preferred embodiments of the current method avoid the very high pressures (greater than 2500 psig) by combining the effects of moderate pressures (about 50 to about 2500 psig) and a reactive gas to kill microorganisms in the food product. These moderate pressures make the current process more economical by reducing equipment and operating costs. In one preferred alternate embodiment, pressures of about 500 to 2500 psig are utilized. However, that is not to say that the current method is limited to pressures below 2500 psig. Obviously, the higher the pressure, the more effective the process would kill pathogenic microorganisms. Thus, the current method can be used in combination with any pressure treatment processes, including those which treat foods at pressures above 2500 psig.

Still referring to FIG. 1, one embodiment of the process includes a step to release the reactive gas pressure 108 by depressurizing the food processing system to a second pressure. In one preferred embodiment, the second pressure is between about 0 to about 50 psig. In another preferred embodiment, the second pressure is a vacuum of between about 1 to about 29.95 inches of mercury. The de-pressurization may or may not contribute to killing the microorganisms present in the food product. In one embodiment, the first pressure is maintained during removal of the reactive gas by using a flow purge method.

Again referring to FIG. 1, during or after the release of the reactive gas from the food processing system, a step feeds inert gas into the food processing system 110. The inert gas and residual reactive gases that may be in the food product are removed in a removing step 112. As used herein, “inert gas” refers to any non-oxidative gas known to one of ordinary skill in the art that will not adversely react with the food product and does not adversely affect the taste of the product. Preferred inert gases include, but are not limited to nitrogen (N₂), helium (He), argon (Ar), krypton (Kr), xenon (Xe), neon (Ne), or mixtures thereof. The inert gas may be filtered in a filtering step (not shown) to prevent contamination of the food product by microbes, bacteria, viruses, or spores in the inert gas. The reactive gas is effectively removed when it is at levels low enough such that the presence of residual reactive gas will not adversely affect the treated food product, particularly the taste, texture, or appearance of the food, after it is packaged. The food processing system may be “flow purged” with the inert gas, or “pressure purged” with the inert gas to remove the residual reactive gas 112. Flow purging is accomplished by flowing the inert gas into the food processing system while simultaneously removing gas from the system for a period of time effective to remove the reactive gas from the food product. Pressure purging is accomplished by pressurizing and depressurizing the food processing system with inert gas between specified pressures for a number of times to effectively remove the reactive gas from the food product. Once the reactive gas is removed to sufficiently low levels, the treated product may be packaged or sent to other processes for further treatment or use.

Preferred embodiments of the process typically maintain a relatively low temperature compared to processes that treat food products by heat (I.E. pasteurization). The food product is typically, but not necessarily, at a temperature of about 0-70° C. when practicing the current process. Alternately, a first temperature is established during the hold step 106 of about 0-70° C. followed by a second temperature of about 0-40° C. in the removal step 112.

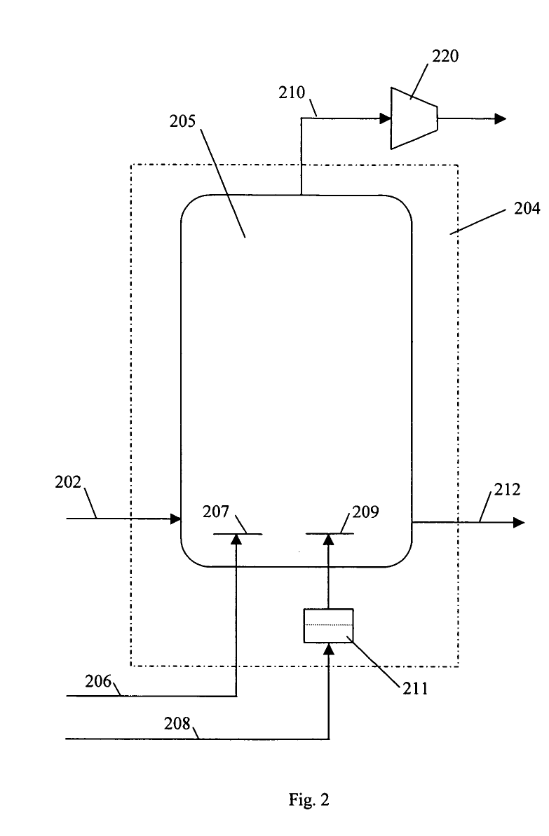

Referring to FIG. 2, one preferred system for implementing the current invention feeds the raw food product 202 to a food processing system 204 that comprises a single tank 205 for treatment. Using this configuration, the food processing system 204 is pressurized with the reactive gas 206 to establish a first pressure. The reactive gas 206 can be fed into the food processing system 204 by using a reactive gas feed device 207, which can be a membrane, sparger, or combination thereof. After a period of time effective for the reactive gas to sufficiently weaken or kill the microorganisms present, the reactive gas is released from the food processing system 204. Typically, but not necessarily, the reactive gas is released by depressurizing the food processing system 204 to a second pressure. Lower pressures facilitate the removal of the reactive gas from the food product, thus one preferred embodiment would include a vacuum pump 220 in the vent system 210. Next, an inert gas 208 is fed to the food processing system 204 using a flow or pressure purge technique described above to remove the residual reactive gas from the food processing system 204 and the food product. The inert gas 208 can be fed into the food processing system 204 by using an inert gas feed device 209, which can be a pipe, nozzle, membrane, sparger, or combination thereof. The inert gas may optionally be filtered by a sub-micron filter 211 to prevent contamination of the food product by microbes, bacteria, viruses, or spores in the inert gas. The residual reactive gas 206 and the inert gas 208 are typically removed via a vent system 210. The treated food product 212 is then transferred for further treatment, use, or packaging.

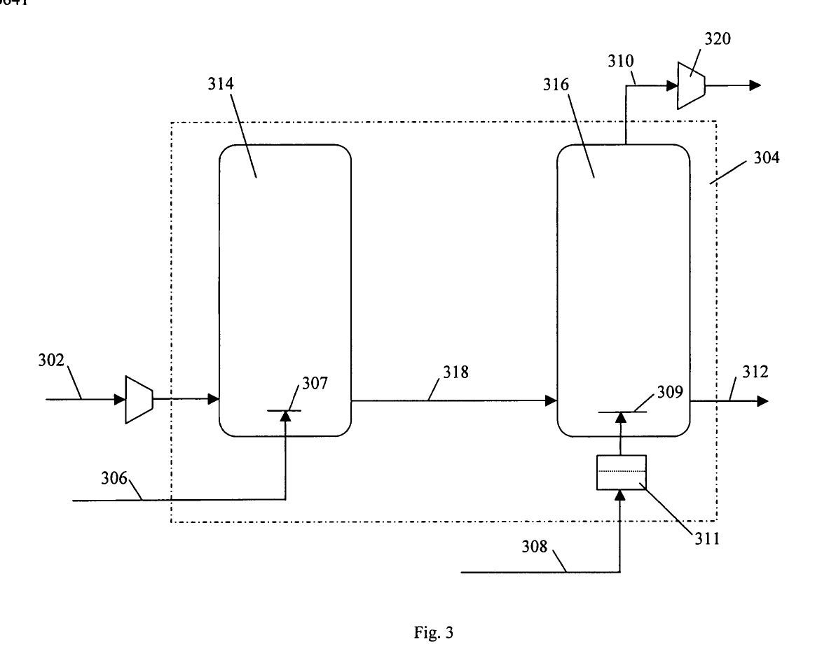

Referring to FIG. 3, another preferred method for implementing the current invention is to continuously feed the raw food product 302 to a food processing system 304 that comprises a first tank 314 and a second tank 316. Using this configuration, the first tank 314 is pressurized with the reactive gas 306 to establish a first pressure. The reactive gas 306 can be, but is not necessarily, fed into the first tank 314 by using a reactive gas feed device 307, which can be a membrane, sparger, or combination thereof. The raw food product 302 is fed into the first tank 314 as a pressurized stream where it reacts with the reactive gas to form an intermediate food product 318. The intermediate food product 318 is continuously transferred to the second tank 316. The first tank 314 is sized such that the food product is retained in the first tank 314 for a period of time effective for the reactive gas to sufficiently weaken or kill the microorganisms present. The pressure in the second tank 316 is typically, but not necessarily significantly lower than the first tank 314. Lower pressures facilitate the removal of the reactive gas from the food product, thus one preferred embodiment would include a vacuum pump 320 in the vent system 310. An inert gas 308 is continuously fed to the second tank 316 to remove the residual reactive gas from the intermediate product 318 and form the treated food product 312. The inert gas 308 can be fed into the second tank 316 by using an inert gas feed device 309, which can be a membrane, sparger, or combination thereof. The inert gas may optionally be filtered by a sub-micron filter 311 to prevent contamination of the food product by microbes, bacteria, viruses, or spores. The treated food product 312 is then transferred for further treatment, use, or packaging.

Other embodiments of the current method may include the use of more than two tanks or processing devices wherein the food product may be subjected to a number of pressurizing and/or purging steps to effectively kill microorganisms and preserve the food product.

The method of the current invention may optionally include packaging of the food or food product comprising placing the food or food product in a container and sealing the container. A vacuum may be optionally applied to the container to remove air or other gas from the container. An inert gas may be further optionally injected into the container, either with or without the use of a vacuum step. The process may be operated in various configurations of batch or continuous operation. The inert gas may be applied before, after or both before and after the use of a vacuum step.

In one preferred embodiment, the food or food product is treated by the current treatment method and subsequently placed in a container. A vacuum is applied to the container to remove air or other gas from the container and the container is sealed to maintain the vacuum in the container.

The container used to contain the food or food product is not particularly limited and includes disposable and reusable containers of all forms, including those that may be microwavable and/or oven-proof. The container may include a cover or cap designed for the container or may be closed or sealed with a permeable or impermeable film or metal foil.

The present invention may be advantageously used to destroy viruses, bacteria, and/or fungi. Preferably, the microorganisms destroyed are those causing food-borne illnesses. As used herein, the term “food-borne” illness means any single or combination of illnesses caused by microorganisms in mammals consuming foods containing those microorganisms.

Although the present invention has been described in considerable detail with reference to certain preferred versions thereof, other versions are possible. For example, various methods can be used to affect the removal of the residual reactive gases from the food product using an inert gas. Furthermore, the invention may include a variety of reactive gases known in the art beyond those mentioned herein. Therefore, the spirit and scope of the appended claims should not be limited to the description of one of the preferred versions contained herein. The intention of the applicants is to cover all modifications, equivalents, and alternatives falling within the spirit and scope of the invention as defined by the appended claims.

1. A method for treating food products comprising the steps of:
a) supplying a food product to a food processing system;
b) feeding a reactive gas to said food processing system to establish a first pressure in said food processing system,
c) holding said first pressure for a period of time sufficient to treat said food product;
d) feeding an inert gas into said food processing system; and
e) removing said inert gas from said food processing system, wherein said inert gas removes residuals of said reactive gas from said food processing system.

2. The method of claim 1, further comprising the step of releasing said reactive gas from said food processing system before said feeding inert gas step.

3. The method of claim 2, wherein said food product is a liquid food product.

4. The method of claim 3, wherein said first pressure is in a range of about 50-2500 psig.

5. The method of claim 4, wherein said releasing step establishes a second pressure in said food processing system, wherein said second pressure is about 0 to about 50 psig.

6. The method of claim 4, wherein said releasing step establishes a second pressure in said food processing system, wherein said second pressure is a vacuum of about 1 to about 29.95 inches of mercury.

7. The method of claim 4, wherein said range is about 500-2500 psig.

8. The method of claim 3, wherein said releasing reactive gas step occurs before said feeding inert gas step.

9. The method of claim 1, wherein said reactive gas comprises a gas selected from the group consisting of ozone, CO₂, N₂O, and mixtures thereof.

10. The method of claim 1, wherein said reactive gas comprises a gas selected from the group consisting of CO₂, N₂O, and mixtures thereof.

11. The method of claim 1, wherein said removing inert gas step follows said feeding inert gas step.

12. The method of claim 1, wherein said inert gas comprises a gas selected from the group consisting of N₂, He, Ar, Kr, Xe, Ne, and mixtures thereof.

13. The method of claim 1, further comprising the step of filtering said inert gas, wherein said filtering prevents contamination of said food product by microbes, bacteria, viruses, or spores.

14. The method of claim 1, further comprising the step of establishing a first temperature in said food processing system of about 0-70° C.

15. The method of claim 14, wherein said first temperature is established during said holding step, and further comprising establishing a second temperature in said food processing system after said holding step.

16. The method of claim 15, wherein said second temperature is about 0-40° C.

17. The method of claim 1, wherein said food processing system comprises a reactive gas feed device, wherein said reactive gas feed device is selected from the group consisting of membranes, spargers, and combinations thereof.

18. The method of claim 1, wherein said food processing system comprises an inert gas feed device, wherein said inert gas feed device is selected from the group consisting of membranes, spargers, and combinations thereof.

19. The method of claim 18, wherein said food processing system further comprises a sub-micron filter.
